(19) United States
(12) Patent Application Publication
(10) Pub. No.: US 2014/0072807 A1
(43) Pub. Date: Mar. 13, 2014

(54) RESIN COMPOSITIONS AND USES OF THE SAME

(71) Applicants: Te-Liang YU, Chupei City (TW); Hsien-Te CHEN, Chupei City (TW); Chih-Wei LIAO, Chupei City (TW)

(72) Inventors: Te-Liang YU, Chupei City (TW); Hsien-Te CHEN, Chupei City (TW); Chih-Wei LIAO, Chupei City (TW)

(73) Assignee: TAIWAN UNION TECHNOLOGY CORPORATION, Chupei City (TW)

(21) Appl. No.: 13/675,342

(22) Filed: Nov. 13, 2012

(30) Foreign Application Priority Data
Sep. 10, 2012 (TW) 101132965

(51) Int. Cl. C08L 63/00; C08K 3/00; C09D 163/00; C08K 3/36; C08K 3/40; C08K 3/26; C08K 3/34

(52) U.S. Cl. CPC C08L 63/00; C08K 3/26; C08K 3/0083; C08K 3/346; C08K 3/36; C08K 3/40; C09D 163/00
USPC 428/416; 523/457

(57) ABSTRACT

A resin composition is provided. The resin composition comprises an epoxy resin, a first filler containing calcium carbonate and hydrated magnesium silicate and a hardener, wherein the first filler has a diameter ranging from about 0.1 μm to about 100 μm; and the amount of the first filler is about 1 part by weight to about 150 parts by weight per 100 parts by weight of the epoxy resin.

CLAIM FOR PRIORITY

This application claims the benefit of Taiwan Patent Application No. 101132965, filed on Sep. 10, 2012.

### CROSS-REFERENCES TO RELATED APPLICATIONS

Not applicable.

### BACKGROUND OF THE INVENTION

1. Field of the Invention

The present invention relates to a resin composition. Specifically, the present invention relates to a resin composition comprising calcium carbonate and hydrated magnesium silicate, and a prepreg and laminate prepared using the same.

2. Descriptions of the Related Art

Printed circuit boards are circuit substrates that are used for electronic devices to load other electronic components and to electrically connect the components to provide a stable circuit working environment. Thus, printed circuit boards require high thermal resistance, size stability, solder resistance, electrical properties, processability, etc. With industrial development, the requirements for printed circuit boards in communication and computing electronic products (such as communication host, computer servers, etc.) and electrical products have increased. The aforementioned printed circuit boards usually have a multi-layered structure.

Printed circuit boards with a multi-layered structure are generally provided using the following methods: immersing a reinforcing material (e.g. glass fiber fabric) into a resin (e.g. epoxy resin); curing the immersed glass fiber fabric into a half-hardened state (i.e. B-stage) to obtain a prepreg; subsequently, superimposing expected layers of the prepregs and superimposing a metal foil on at least one external surface of the superimposed prepregs to provide a superimposed object; then hot-pressing the superimposed object (i.e. C-stage), to obtain a metal clad laminate; etching the metal foil on the surface of the metal clad laminate to form a defined circuit pattern; and finally, digging a plurality of holes on the metal clad laminate and plating these holes with a conductive material to form via holes to accomplish the preparation of the printed circuit board.

In the resin composition for preparing printed circuit boards, there may be additional additives such as a hardening promoter, a dispersing agent, a flexibilizer, a retardant, a releasing agent and a filler to provide the printed circuit board with the specific physicochemical properties to fit the needs of its application. For example, TW 591989 uses calcium carbonate in the resin as an inorganic filler to improve the properties of the prepared laminate such as size stability, thermal resistance and the like. However, the addition of calcium carbonate usually results in the agglomeration of the resin composition which creates a limited application of the prepared laminate because the pin of the drill will be rapidly worn during the drilling process of the prepared laminate. Thus, the life of the drill is shortened.

In this regard, the present invention provides a resin composition for preparing a laminate, wherein the resin composition comprises calcium carbonate and hydrated magnesium silicate. The resin composition of the invention possesses a short gel time and does not give rise to any agglomeration problem. The laminate prepared thereby is provided with outstanding heat resistance and provides acceptable mechanical integrity without causing excessive wear on drill and thus, further meets the requirements of its application.

### SUMMARY OF THE INVENTION

An objective of the present invention is to provide a resin composition, comprising: an epoxy resin; a first filler containing calcium carbonate and hydrated magnesium silicate; and a hardener, wherein the first filler has a diameter ranging from about 0.1 μm to about 100 μm. The amount of the first filler is about 1 part by weight to about 150 parts by weight per 100 parts by weight of the epoxy resin.

Another objective of the present invention is to provide a prepreg, which is prepared by immersing a substrate into the resin composition mentioned above and drying the immersed substrate.

Yet another objective of the present invention is to provide a laminate comprising a synthetic layer and a metal layer, where the synthetic layer is made from the prepreg mentioned above.

To render the above objectives, technical features and advantages of the present invention more apparent, the present invention will be described in detail with reference to some embodiments hereinafter.

### DESCRIPTION OF THE PREFERRED EMBODIMENT

Hereinafter, some embodiments of the present invention will be described in detail with reference to the appended drawings. However, without departing from the spirit of the present invention, the present invention may be embodied in various embodiments and should not be limited to the embodiments described in the specification and drawings.

Furthermore, for clarity, the size of each element and each area may be exaggerated in the appended drawings and not depicted in its actual proportion. Unless it is additionally explained, the expressions “a,” “the,” or the like recited in the specification of the present invention (especially in the claims) should include both the singular and the plural forms. Furthermore, unless it is additionally explained, while describing the constituents in the solution, mixture and composition in the specification, the amount of each constituent is counted based on the solid content, i.e., disregarding the weight of the solvent.

The inventor found that in the resin composition, the use of calcium carbonate together with hydrated magnesium silicate can not only shorten the gel time of the resin composition and effectively improve the thermal resistance of the laminate prepared thereby, but also obviate the disadvantage of using calcium carbonate alone (that is, the resin composition tends to form agglomeration and the laminate prepared thereby will wearout the drill). Therefore, one feature of the present invention is to use calcium carbonate together with hydrated magnesium silicate in a resin composition to provide a resin composition with short gel time and without agglomeration. The laminate prepared thereby is provided with outstanding heat resistance and will not wearout the drill during the digging process.

Specifically, the resin composition of the present invention comprises an epoxy resin, a first filler containing calcium carbonate and hydrated magnesium silicate, and a hardener. The first filler has a diameter ranging from about 0.1 μm to about 100 μm, and preferably from about 1 μm to about 20 μm. If the amount of the particles with a diameter smaller than 0.1 μm in the first filler is higher than 50%, the filler particles may agglomerate with each other. In addition, if the amount of the particles with a diameter larger than 100 μm in the first filler is higher than 50%, the properties of the prepared laminates are nonuniform and the first filler with a large diameter easily leads to wearing of the drill. In some embodiments of the present invention, the first filler with a diameter distribution of about 5 μm is illustrated as the first filler. Furthermore, in the resin composition of the present invention, the amount of the first filler is about 1 part by weight to about 150 parts by weight, and preferably about 5 parts by weight to about 90 parts by weight per 100 parts by weight of the epoxy resin. If the amount of the first filler is less than about 1 part by weight, the desired heat resistance may not be obtained; and if the amount of the first filler is higher than about 150 parts by weight, the Mohs hardness of the laminate will be increased which will worsen the wear on the drill.

In the first filler of the resin composition of the present invention, both calcium carbonate and hydrated magnesium silicate are included. The trivial name of “hydrate magnesium silicate” is talcum, which may be further processed and milled to provide the so-called talcum powder among which 3MgO.4SiO₂.H₂O is the main component. The higher the ratio of the main constituent, the higher the purity of the talcum powder. Any other crystal structures with a molecular mole ratio that is different from the aforementioned main component or other elements are regarded as impurities. The ratio between the weight of the calcium carbonate and the weight of the hydrated magnesium silicate ranges from about 1:10 to about 2:1, and preferably from about 1:5 to about 1:1. If the amount of calcium carbonate is less than the aforesaid range, the desired heat resistance may not be obtained; and if the amount of hydrated magnesium silicate is less than the aforesaid range, agglomeration in the resin composition may not be effectively avoided and the drill wear during the processing of the prepared laminate may not be effectively decreased. The first filler may be provided by any proper method. For example, the first filler may be provided by mixing calcium carbonate and hydrated magnesium silicate, or directly using a material containing both calcium carbonate and hydrated magnesium silicate, e.g., calcium-containing talcum powders. The term “calcium-containing talcum powder” here is different from “talcum powder” in the market. “Talcum powder” generally used in the industry has 3MgO.4SiO₂.H₂O as a main constituent and contains no calcium. However, “calcium-containing talcum powders” here are unprocessed and contain calcium carbonate.

In the resin composition of the present invention, the epoxy resin contained is a resin with at least two epoxy groups in the molecular structure, such as a bromine-containing or non-halogen bifunctional or multiple functional epoxy resin, a phenol novolac epoxy resin, a phosphorus-containing epoxy resin, etc. In some embodiments of the present invention, a bromine-containing epoxy resin or a phosphorus-containing epoxy resin is illustrated as the epoxy resin.

In the resin composition of the present invention, the hardener can promote or adjust the bridging among the molecules to thereby obtain a network structure. The type of hardener is not particularly limited; it can be any hardener which can provide the desired hardening effect. For example, but not limited thereto, the hardener used in the resin composition of the present invention can be a conventional hardener selected from a group consisting of dicyandiamide (Dicy), phenol novolac (PN), 4,4′-diaminodiphenyl sulfone (DDS), styrene maleic anhydride copolymer (SMA), benzoxazine and its ring-opened polymer, bismaleimide, triazine and combinations thereof. In some embodiments of the present invention, PN or Dicy is illustrated as the hardener.

The amount of the hardener in the resin composition of the present invention depends on the number of epoxy groups contained in the epoxy resin and the number of functional groups that is reactive to the epoxy groups and contained in the hardener. Generally, the hardener is used in an amount such that the ratio between the number of functional groups being reactive to epoxy groups and contained in the hardener to the number of epoxy groups contained in the epoxy resin ranges from about 1:2 to about 2:1 The desired hardening effect may be effectively obtained within the aforesaid ratio. However, the amount of hardener can still be adjusted depending on the users' needs without affecting the hardening effect and is not limited thereto. In some embodiments of the present invention, the ratio between the number of functional groups that is reactive to the epoxy groups and contained in the hardener to the number of epoxy groups contained in the epoxy resin is about 1:1.

Depending on the users' needs, the resin composition of the present invention may further comprise a second filler or other additives. The second filler here refers to other conventional fillers except calcium carbonate and hydrated magnesium silicate, and its specific examples comprise but not limited thereto: silica, glass powder, kaolin, pryan, mica and combinations thereof. The examples of other additives comprises a hardening promoter, a dispersing agent, a flexibilizer, a retardant, a releasing agent, a silane coupling agent and combinations thereof, but not limited thereto. For example, a hardening promoter selected from the group consisting of 2-methyl-imidazole (2MI), 2-ethyl-4-methyl-imidazole (2E4MI), 2-phenyl-imidazole (2PI) and combinations thereof, but not limited thereto, may be added to improve the hardening effect. As for the amount of the additives, it can be easily adjusted by persons with ordinary skill in the art depending on the needs based on the disclosure of the specification and is not particularly limited.

For actual application, the resin composition of the present invention may be prepared into varnish by evenly mixing the epoxy resin, the first filler and the hardener through a stirrer; and dissolving or dispersing the mixture into a solvent, for subsequent applications. The solvent here can be any inert solvent which can dissolve (or disperse) but not react with the components of the resin composition of the present invention. For example, the solvent may be selected from a group consisting of N,N-dimethyl formamide (DMF), methyl ethyl ketone (MEK), propylene glycol monomethyl ether (PM), propylene glycol monomethyl ether acetate (PMA), cyclohexanone, acetone, toluene, y-butyrolactone, butanone, xylene, methyl isobutyl ketone, N,N-dimethyl acetamide (DMAc), N-methyl-pyrolidone (NMP), and combinations thereof, but is not limited thereto. The amount of the solvent is not particularly limited as long as the components of the resin composition can be evenly mixed. In some embodiments of the present invention, DMF is used as the solvent and in an amount of about 80 parts by weight per 100 parts by weight of the epoxy resin.

The present invention further provides a prepreg which is obtained by immersing a substrate (i.e. a reinforcing material) into the resin composition of the present invention dissolved (or dispersed) by a solvent so that the resin composition is adhered to the surface of the substrate, providing an immersed substrate and drying the immersed substrate. A conventional reinforcing material includes a glass fiber cloth (a glass fiber fabric, a glass fiber paper, a glass fiber mat, etc.), a kraft paper, a short fiber cotton paper, a nature fiber cloth, an organic fiber cloth, etc. In some embodiments of the present invention, 7628 glass fiber cloths are illustrated as the reinforcing materials, and the reinforcing materials are heated and dried at 180° C. for 2 to 10 minutes (B-stage) to provide half-hardened prepregs.

The abovementioned prepregs can be used in producing laminates. Therefore, the present invention further provides a laminate comprising a synthetic layer and a metal layer, wherein the synthetic layer is made from the above prepregs. The laminate may be prepared by following process: superimposing a plurality of prepregs and superimposing a metal foil (such as copper foil) on at least one external surface of the superimposed prepregs to provide a superimposed object; performing a hot-pressing operation onto the object to obtain the laminate. Moreover, a printed circuit board can be obtained by making a pattern on the metal foil of the laminate.

The present invention will be further illustrated by the embodiments hereinafter, wherein the measuring instruments and methods are respectively as follows:

[Filler Dispersing Extent Test]

The extent of filler dispersion is tested by stirring the prepared resin composition with a stirrer for 1 hour (stiffing rate: 3000 rpm), and then observing the number of agglomerates with a size larger than 200 μm per 100 ml of the resin composition.

[Gel Time Test]

The method for testing gel time comprises the following steps: placing 0.2 g of resin composition sample on a hot plate at about 171° C. and subjecting the sample to form a disc (2 cm² in area); and calculating the time required for the sample to not adhere to the stirring rod used for stirring the sample or until the sample becomes cured. The time required is regarded as the gel time.

[H₂O Absorption Test]

The H₂O absorption of the laminate is tested by the pressure cooker test (PCT), i.e., subjecting the laminate into a pressure container (121° C., 100% R.H. and 1.2 atm) for 1 hour.

[Solder Resistance Test]

The solder resistance test is carried out by immersing the dried laminate in a solder bath at 288° C., observing and recording the time immersed for popcorn condition (e.g. observing the laminate whether there is any defect such as delamination and expansion) of the laminate occurred.

[Peeling Strength Test]

Peeling strength refers to the bonding strength between the metal foil and a laminated prepreg, and which is usually expressed by the force required for vertically peeling the clad copper foil with a width of ⅛ inch from the surface of the laminated prepreg.

[Glass Transition Temperature Test]

Glass transition temperature (Tg) is measured by using a dynamic mechanical analyzer (DMA), wherein the measuring methods are IPC-TM-650.2.4.25C and 24C testing method of the Institute for Interconnecting and Packaging Electronic Circuits (IPC).

[Thermal Decomposition Temperature Test]

The thermal decomposition temperature test is carried out by measuring the mass loss of the sample with a thermogravimetric analyzer (TGA). The temperature where the weight loss is up to 5% is regarded as the thermal decomposition temperature.

[Dielectric Constant and Dissipation Factor Measurement]

The dielectric constant (Dk) and dissipation factor (Df) are measured according to ASTM D150 under an operating frequency of 1 GHZ.

[Coefficient of Thermal Expansion (CTE) Test]

The z-axis expansion % of the sample (a laminate in a size of 3 mm²) are tested by the thermal expansion analyzer of TA instrument company (model No.: TA 2940) between a temperature gap ranging from 50° C. to 260° C. (heating rate: 10° C./min)

[Anti-conductive Anodic Filament (Anti-CAF) Test]

The hours of the anti-conductive anodic filament of the laminate are measured according to JIS-Z3284.

[Wear Percentage on the Drill]

The wear percentage on the drill is tested by drilling the laminate using a drill with a diameter of 0.3 mm and repeating 800 times, and then observing the ratio of the worn area of the drill top surface to the total cross-sectional area.

### Examples

### Preparation of the Resin Composition

### Example 1

According to the ratio shown in Table 1, bromines-containing epoxy resin (Hexion 1134), Dicy hardener, 2-methyl-imidazole (2MI), calcium carbonate and hydrated magnesium silicate (the first filler) and DMF solvent were stirred at room temperature with a stirrer for about 120 minutes to obtain resin composition 1. The extent of filler dispersion and the gel time of resin composition 1 were measured and the results are tabulated in Table 1.

### Example 2

The preparation procedures of Example 1 were repeated to prepare resin composition 2, except that the ratio of calcium carbonate and hydrated magnesium silicate was adjusted, as shown in Table 1. The extent of filler dispersion and the gel time of resin composition 2 were measured and the results are tabulated in Table 1.

### Example 3

The preparation procedures of Example 1 were repeated to prepare resin composition 3, except that the first filler was replaced by calcium-containing talcum powders (IANTEAI Co., Ltd.), as shown in Table 1 (the unprocessed calcium-containing talcum powders were obtained directly from mining, and contained about 5 wt % to 24 wt % of calcium carbonate). The extent of filler dispersion and the gel time of resin composition 3 were measured and the results are tabulated in Table 1.

### Example 4

The preparation procedures of Example 3 were repeated to prepare resin composition 4, except that the bromine-containing epoxy resin was replaced by phosphorus-containing epoxy resin (CCP 330), as shown in Table 1. The extent of filler dispersion and the gel time of resin composition 4 were measured and the results are tabulated in Table 1.

### Example 5

The preparation procedures of Example 1 were repeated to prepare resin composition 5, except that the Dicy hardener was replaced by PN hardener, as shown in Table 1. The extent of filler dispersion and the gel time of resin composition 5 were measured and the results are tabulated in Table 1.

### Example 6

The preparation procedures of Example 1 were repeated to prepare resin composition 6, except that the ratio of calcium carbonate and hydrated magnesium silicate in the first filler was adjusted, as shown in Table 1. The extent of filler dispersion and the gel time of resin composition 6 were measured and the results are tabulated in Table 1.

### Example 7

The preparation procedures of Example 3 were repeated to prepare resin composition 7, except that the amount of calcium-containing talcum powders was adjusted, as shown in Table 1. The extent of filler dispersion and the gel time of resin composition 7 were measured and the results are tabulated in Table 1.

### Example 8

The preparation procedures of Example 3 were repeated to prepare resin composition 8, except that the amount of calcium-containing talcum powder was adjusted, as shown in Table 1. The extent of filler dispersion and the gel time of resin composition 7 were measured and the results are tabulated in Table 1.

### Comparative Example 1

The preparation procedures of Example 1 were repeated to prepare comparative resin composition 1, except that calcium carbonate was not used and only hydrated magnesium silicate was used as filler, as shown in Table 1. The extent of filler dispersion and the gel time of comparative resin composition 1 were measured and the results are tabulated in Table 1.

### Comparative Example 2

The preparation procedures of Example 1 were repeated to prepare comparative resin composition 2, except that only calcium carbonate was used as filler, as shown in Table 1. The extent of filler dispersion and the gel time of comparative resin composition 2 were measured and the results are tabulated in Table 1.

TABLE 1

| | | | | | | | | | | | Compara- | Compara- |
|---|---|---|---|---|---|---|---|---|---|---|---|---|
| | | | | | | | | | | | tive | tive |
| | | | Example 1 | Example 2 | Example 3 | Example 4 | Example 5 | Example 6 | Example 7 | Example 8 | example 1 | example 2 |
| epoxy | bromine- | | 100 | 100 | 100 | — | 100 | 100 | 100 | 100 | 100 | 100 |
| resin | containing epoxy | | | | | | | | | | | |
| (parts by | resin | | | | | | | | | | | |
| weight) | phosphorous- | | — | — | — | 100 | — | — | — | — | — | — |
| | containing epoxy | | | | | | | | | | | |
| | resin (DOPO) | | | | | | | | | | | |
| hardener | Dicy | (unit: | 1 | 1 | 1 | 1 | — | 1 | 1 | 1 | 1 | 1 |
| | PN | equivalent | — | — | — | — | 1 | — | — | — | — | — |
| | | ratio | | | | | | | | | | |
| | | of the | | | | | | | | | | |
| | | number of | | | | | | | | | | |
| | | functional | | | | | | | | | | |
| | | groups | | | | | | | | | | |
| | | being | | | | | | | | | | |
| | | reactive to | | | | | | | | | | |
| | | epoxy | | | | | | | | | | |
| | | groups | | | | | | | | | | |
| | | and | | | | | | | | | | |
| | | contained | | | | | | | | | | |
| | | in the | | | | | | | | | | |
| | | hardener | | | | | | | | | | |
| | | to the | | | | | | | | | | |
| | | number of | | | | | | | | | | |
| | | epoxy | | | | | | | | | | |
| | | groups | | | | | | | | | | |
| | | contained | | | | | | | | | | |
| | | in the | | | | | | | | | | |
| | | epoxy | | | | | | | | | | |
| | | resin) | | | | | | | | | | |

| | | | | | | | | | | | |
|---|---|---|---|---|---|---|---|---|---|---|---|
| promoter | 2MI | 0.5 | 0.5 | 0.5 | 0.5 | 0.5 | 0.5 | 0.5 | 0.5 | 0.5 | 0.5 |
| (parts by | | | | | | | | | | | |
| weight) | | | | | | | | | | | |
| first | calcium | 8 | 4 | — | — | 8 | 12 | — | — | 0 | 24 |
| filler | carbonate | | | | | | | | | | |
| (parts by | hydrated | 16 | 20 | — | — | 16 | 12 | — | — | 24 | 0 |
| weight) | magnesium | | | | | | | | | | |
| | silicate | | | | | | | | | | |
| | carbon-containing | — | — | 24 | 24 | — | — | 10 | 80 | — | — |
| | talcum powder | | | | | | | | | | |
| solvent | DMF, MEK, etc. | 80 | 80 | 80 | 80 | 80 | 80 | 80 | 80 | 80 | 80 |
| (parts by | | | | | | | | | | | |
| weight) | | | | | | | | | | | |

| | | | | | | | | | | |
|---|---|---|---|---|---|---|---|---|---|---|
| filler dispersing extent (the | 2 | 1 | No | No | No | No | No | No | No | >5 |
| extent of filler dispersion) | | | detection | detection | detection | detection | detection | detection | detection | |
| gel time (sec) | 268 | 271 | 269 | 271 | 263 | 262 | 272 | 263 | 278 | 258 |

As shown in Table 1, the resin composition of the present invention by using calcium carbonate together with hydrated magnesium silicate can not only adjust the gel time of the resin composition and thus, reduce the time required for the preparation of prepregs and laminates, but also effectively solve the agglomeration problem of the resin composition when using calcium carbonate alone as a filler (i.e. poor filler dispersion).

[Preparation of the Laminate]

The laminate was prepared using resin compositions of Examples 1 to 8 and comparative examples 1 and 2, respectively. In detail, one of those resin compositions was coated on 7628 glass fiber cloths by a roll coater. The coated 7628 glass fiber cloths were then placed in an oven and dried at 180° C. for 2 to 10 minutes to produce a prepregs in a half-hardened state (resin content: about 42%). Four pieces of the prepregs were superimposed and two sheets of copper foil (1 oz) were respectively superimposed on the two external surfaces of the superimposed prepregs to provide a superimposed object. A hot-pressing operation was performed on each of the prepared objects to provide laminates 1 to 8 (corresponding to resin compositions 1 to 8) and comparative laminates 1 and 2 (corresponding to comparative resin compositions 1 and 2). Herein, the hot-pressing conditions are as follows: raising the temperature to 180° C. with a heating rate of 2.0° C./min, and hot-pressing for 60 minutes under the full pressure of 15 kg/cm² (initial pressure is 8 kg/cm²) at 180° C.

The H₂O absorption, solder resistance, peeling strength, glass transition temperature (Tg), thermal decomposition temperature (Td), dielectric constant (Dk), dissipation factor (DO, z-axis expansion percentage, the hours of anti-conductive anodic filament (Anti-CAF) and wear percentage on the drill of the laminates 1 to 8 and comparative laminates 1 and 2 were analyzed and the results are tabulated in Table 2.

TABLE 2

| | | | | | | | | | | comparative | comparative |
|---|---|---|---|---|---|---|---|---|---|---|---|
| Test items | unit | laminate 1 | laminate 2 | laminate 3 | laminate 4 | laminate 5 | laminate 6 | laminate 7 | laminate 8 | laminate 1 | laminate 2 |
| H₂O | % | 0.145 | 0.142 | 0.144 | 0.146 | 0.148 | 0.147 | 0.154 | 0.143 | 0.141 | 0.152 |
| absorption | | | | | | | | | | | |
| solder | minute | >15 | >10 | >15 | >10 | >10 | >15 | >10 | >10 | >10 | 9.5 |
| resistance | | | | | | | | | | | |
| peeling | pound/ | 8.8 | 8.7 | 8.6 | 8.6 | 8.6 | 8.7 | 9.1 | 7.5 | 8.6 | 8.8 |
| strength | inch | | | | | | | | | | |
| glass | ° C. | 176 | 173 | 175 | 171 | 173 | 179 | 172 | 178 | 171 | 178 |
| transition | | | | | | | | | | | |
| temperature | | | | | | | | | | | |
| (Tg) | | | | | | | | | | | |
| thermal | ° C. | 325 | 321 | 323 | 371 | 374 | 329 | 319 | 326 | 312 | 329 |
| decomposition | | | | | | | | | | | |
| temperature | | | | | | | | | | | |
| (Td) | | | | | | | | | | | |
| dielectric | GHz | 4.5 | 4.5 | 4.5 | 4.5 | 4.6 | 4.6 | 4.6 | 4.3 | 4.5 | 4.7 |
| constant (Dk) | | | | | | | | | | | |
| dissipation | GHz | 0.015 | 0.016 | 0.016 | 0.016 | 0.017 | 0.017 | 0.017 | 0.014 | 0.016 | 0.017 |
| factor (Df) | | | | | | | | | | | |
| z-axis | % | 3.2 | 3.2 | 3.2 | 3.2 | 3.2 | 3.2 | 3.2 | 3.2 | 3.2 | 3.4 |
| expansion | | | | | | | | | | | |
| percentage | | | | | | | | | | | |
| Anti-CAF | hour | >3000 | >3000 | >3000 | >3000 | >3000 | >3000 | >3000 | >3000 | >3000 | >3000 |
| wear | % | 20 | 15 | 20 | 20 | 20 | 25 | 10 | 28 | 10 | 40 |
| percentage of | | | | | | | | | | | |
| the drill | | | | | | | | | | | |

As shown in Table 2, the heat resistance of the laminate prepared by conventional resin composition using hydrated magnesium silicate as a hardener is poor (i.e. low Td) (comparative laminate 1), and the laminate prepared by conventional resin composition using calcium carbonate as a hardener causes over-wearing on the drill. By comparison, the laminate prepared by the resin composition of the present invention using calcium carbonate together with hydrated magnesium silicate unexpectedly provides outstanding heat resistance and simultaneously maintains acceptable wear percentage on the drill.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A resin composition, comprising:
an epoxy resin;
a first filler containing calcium carbonate and hydrated magnesium silicate; and,
a hardener,
wherein the first filler has a diameter ranging from about 0.1 μm to about 100 μm, and the amount of the first filler is about 1 part by weight to about 150 parts by weight per 100 parts by weight of the epoxy resin.

2. The resin composition of claim 1, wherein the hardener is in an amount such that the ratio between the number of functional groups being reactive to epoxy groups and contained in the hardener to the number of epoxy groups contained in the epoxy resin ranges from about 1:2 to about 2:1.

3. The resin composition of claim 1, wherein the first filler is calcium-containing talcum powders comprising calcium carbonate.

4. The resin composition of claim 1, wherein the ratio between the weight of the calcium carbonate and the weight of the hydrated magnesium silicate ranges from about 1:10 to about 2:1.

5. The resin composition of claim 1, wherein the amount of the first filler is about 5 parts by weight to about 90 parts by weight per 100 parts by weight of the epoxy resin.

6. The resin composition of claim 1, wherein the hardener is selected from the group consisting of dicyandiamide (Dicy), phenol novolac (PN), 4,4′-diaminodiphenyl sulfone (DDS), styrene maleic anhydride copolymer (SMA), benzoxazine and its ring-opened polymer, bismaleimide, triazine and combinations thereof.

7. The resin composition of claim 1, which further comprises a second filler selected from the group consisting of silica, glass powder, kaolin, pryan, mica and combinations thereof.

8. The resin composition of claim 1, which further comprises an additive selected from the group consisting of a hardening promoter, a dispersing agent, a flexibilizer, a retardant, a releasing agent and combinations thereof.

9. The resin composition of claim 8, wherein the hardener is selected from the group consisting of 2-methyl-imidazole (2MI), 2-ethyl-4-methyl-imidazole (2E4MI), 2-phenyl-imidazole (2PI) and combinations thereof.

10. The resin composition of claim 2, which further comprises an additive selected from the group consisting of a hardening promoter, a dispersing agent, a flexibilizer, a retardant, a releasing agent and combinations thereof.

11. The resin composition of claim 10, wherein the hardener is selected from the group consisting of 2-methyl-imidazole (2MI), 2-ethyl-4-methyl-imidazole (2E4MI), 2-phenyl-imidazole (2PI) and combinations thereof.

12. The resin composition of claim 3, which further comprises an additive selected from the group consisting of a hardening promoter, a dispersing agent, a flexibilizer, a retardant, a releasing agent and combinations thereof.

13. The resin composition of claim 12, wherein the hardener is selected from the group consisting of 2-methyl-imidazole (2MI), 2-ethyl-4-methyl-imidazole (2E4MI), 2-phenyl-imidazole (2PI) and combinations thereof.

14. The resin composition of claim 4, which further comprises an additive selected from the group consisting of a hardening promoter, a dispersing agent, a flexibilizer, a retardant, a releasing agent and combinations thereof.

15. The resin composition of claim 14, wherein the hardener is selected from the group consisting of 2-methyl-imidazole (2MI), 2-ethyl-4-methyl-imidazole (2E4MI), 2-phenyl-imidazole (2PI) and combinations thereof.

16. The resin composition of claim 5, which further comprises an additive selected from the group consisting of a hardening promoter, a dispersing agent, a flexibilizer, a retardant, a releasing agent and combinations thereof.

17. The resin composition of claim 16, wherein the hardener is selected from the group consisting of 2-methyl-imidazole (2MI), 2-ethyl-4-methyl-imidazole (2E4MI), 2-phenyl-imidazole (2PI) and combinations thereof.

18. A prepreg, which is prepared by immersing a substrate into the resin composition of claim 1 to provide an immersed substrate and drying the immersed substrate.

19. A laminate comprising a synthetic layer and a metal layer, wherein the synthetic layer is made from the prepreg of claim 18.
